(19) United States
(12) Patent Application Publication
(10) Pub. No.: US 2012/0078789 A1
(43) Pub. Date: Mar. 29, 2012

(54) OFFLINE TO ONLINE PAYMENT

(75) Inventor: Jeffrey Harrell, San Jose, CA (US)

(73) Assignee: EBAY INC., San Jose, CA (US)

(21) Appl. No.: 12/893,224

(22) Filed: Sep. 29, 2010

(51) Int. Cl. G06Q 20/00

(52) U.S. Cl. 705/44

(57) ABSTRACT

A payer submits a payment request when there has been no connection established with an online payment provider. The payment request is stored on the payer's device, such as a phone, and is transmitted to the payment provider when a connection is established. The payer can submit a plurality of offline payment requests, all of which can be transmitted and processed when received by the payment provider.

### BACKGROUND

1. Field of the Invention

The present invention generally relates to on-line payments, and in particular, to initiating an online payment when offline.

2. Related Art

More and more consumers are purchasing items and services over electronic networks, such as the Internet. Consumers routinely search for and purchase products and services from merchants and individuals alike. The transactions can take place directly between an on-line merchant or retailer and the consumer, where payment is typically made by entering credit card or other financial information. Transactions can also take place with the aid of an on-line payment provider, such as PayPal, Inc. of San Jose, Calif. Such payment providers can make transactions easier and safer for the parties. Payment providers enable payments to be made through many different convenient methods.

Part of the attraction of payment providers is that payments can be made virtually instantaneously. This is possible due to how fast information is communicated to and from the payment provider through such means as dial-up, landline, Wi-Fi, satellite, and cell phones. However, when communication is slow or non-existent, the transaction or payment may be delayed, canceled, or unable to be processed. The user may forget to make the payment later or cancel the transaction altogether, resulting in a lost opportunity for the payment provider, the merchant, and/or the buyer. With on-line transactions and payments becoming more global and wide-spread, this can be a significant problem.

In addition, communication outages or disruptions are very common problems. Even in industrial countries like the United States, users frequently experience problems accessing the Internet or obtaining service on their mobile device. These problems are even more prevalent in locations that are less technically advanced or have large rural or under-developed areas with sporadic or non-existent cellular service.

Thus, there is a need for a user to be able to make a payment even when there is no on-line access to the payment provider.

### SUMMARY

In accordance with different embodiments, a user, who wants to make a payment through a payment provider, but is offline, goes through a normal payment process on a user device, such as a phone. However, without online access, the payment information is stored and queued within the user device. When the device is online or otherwise is able to communicate with the payment provider, any stored payments are transmitted to the payment provider for processing. Once processed, the user and/or the recipient can receive a notice from the payment provider that the payment was made. In another embodiment, the user or payer may use another form of communication to convey an intent to pay with the recipient so that the recipient has some assurance from the user. For example, the communication may be through NFC or Bluetooth.

In one embodiment, the user enters information about the recipient, such as an e-mail or phone number and the amount. The information is processed locally in the device and the user sees a confirmation page, where the user can confirm the payment. The user may submit multiple payments to the same or different parties. In one embodiment, when online, the payments are processed by the payment provider in the order they were submitted. However, the user may set priorities for the payments if desired.

If the payment is approved, the user and/or the recipient is notified. If the payment is denied, the user may be given the option of revising the payment submission or submitting a new payment before the recipient is notified of a declined payment.

Thus, having the ability to submit payments, even when offline, can promote additional transactions or prevent a transaction to be canceled because the user need not wait until an online connection is available before submitting a payment request.

These and other features and advantages of the present invention will be more readily apparent from the detailed description of the embodiments set forth below taken in conjunction with the accompanying drawings.

### BRIEF DESCRIPTION OF THE FIGURES

FIG. 1 is a flowchart showing an offline to online payment process according to one embodiment;

FIG. 2 is a flowchart showing a process for a payment provider in handling an offline payment submission according to one embodiment;

FIG. 3 is a flowchart showing a process for a user or payer in submitting a payment request offline according to another embodiment;

FIG. 4 is block diagram of a networked system suitable for implementing the process of FIGS. 1-3 in accordance with an embodiment of the invention; and

FIG. 5 is a block diagram of a computer system suitable for implementing one or more components in FIG. 4 according to one embodiment of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

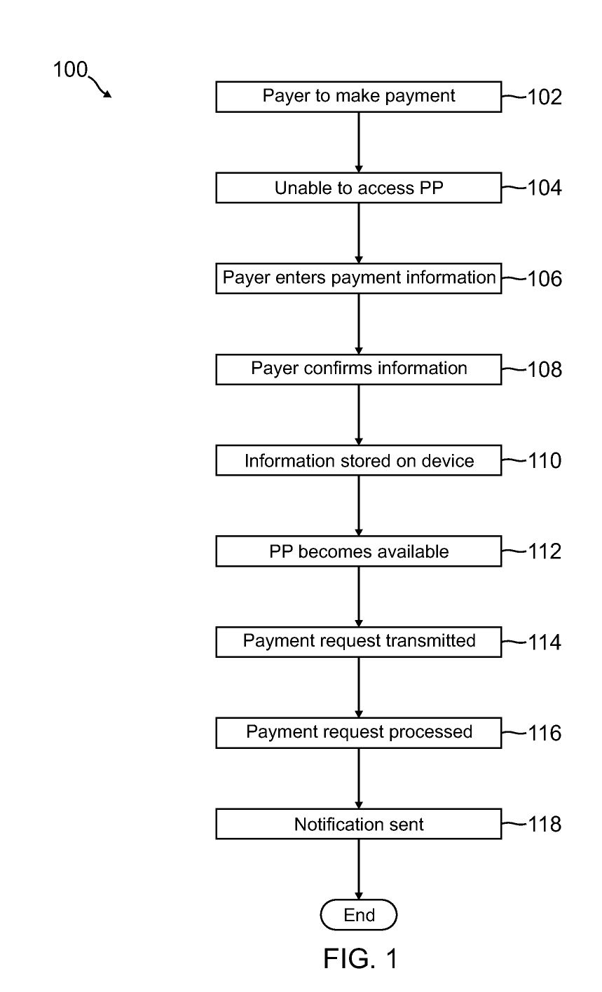

FIG. 1 is a flowchart 100 showing an offline to online payment process according to one embodiment. At step 102, a payer or user wants to make a payment through a payment provider, such as PayPal, Inc. of San Jose, Calif.. The payment may be to any suitable recipient, such as another person, a merchant, or an on-line seller of goods or services. In this non-limiting example, the payment is a person to person payment. Payments may be for a purchase, a donation, gift, loan, debt, or other reason, such as simply a parent giving a child some money.

The payment or money transfer is processed by the payment provider and usually requires a connection or communication with the payment provider. This is usually through an Internet connection via a PC or a connection through a user's phone. In this example, the payer cannot access the payment provider at step 104, which may an inability to connect or maintain a connection with the payment provider. The cause may be many fairly common events, such as a power outage, an interruption in Internet service from the carrier, non-existent or weak cellular coverage, or problems with the payment provider site.

In this case, the payer can still submit a payment request. At step 106, the payer enters information required to make a payment. Typically, the information includes a recipient or payee identifier and an amount. Additional information may also be entered, such as an account number (for the payer and/or the payee), a mailing address, a reference number, and/or notes. The information may be entered from the user's computing device, such as through a phone or PC keypad.

In one embodiment, the payee opens a payment provider app or application on the user's device. The app is typically a software application resident on the user's device. A connection to the payment provider is not required to open the app. Once opened, the user can go through a normal payment flow. For example, the user may be asked to provide log in information, such as an email, username, or other identifier, along with a password or PIN. Because there is no connection with the payment provider, the user may not receive access to the user's account or confirmation of a successful log in. The user may also be asked to provide payment information, such as described above, including a funding source if desired. Once everything is entered, the user can “submit” the information.

After “submission,” the app may compile the information and present it back to the user for confirmation at step 108. The user may then either confirm the information or make any changes or corrections. Once confirmed, the information is stored on the device at 110, such as through the payment provider app. At this point, the payment request is sitting on the device, waiting for transmission to the payment provider. This may only be a few seconds, hours, or even days, depending on the situation.

At some point, the user device is able to communicate with the payment provider, at step 112. Different devices may achieve this in different means. For example, the device may continually try and access the payment provider, do so periodically, or upon certain events such as start up. The device may also not attempt to access the payment provider until the user performs some action, such as attempting to access the payment provider site by entering a URL address or calling an app.

Once communication with the payment provider is established, the payment request is transmitted at step 114. Transmission may be automatic, in that as soon as the connection is made, the request is sent. In other embodiments, the payment request may wait until the user actively sends the request, such as by selecting a “send” button or link.

After the payment provider receives the payment request, the request is processed at step 116. Processing can be conventional processing. For example, the payment provider may first determine whether the payee has an account with the payment provider and/or has a valid funding source for the payment. This can be determined from log in information transmitted from the user that was entered into the app, device information like the phone number from the user device or cookies transmitted with the request, etc. Processing also includes determining whether the payee has sufficient funds to make the specified payment amount. The payment provider may also determine whether information about the payee is sufficient to process the payment. For example, the payment request may include a recipient email, name, business name, web site address, or phone number. With that or other information, the payment provider may first determine whether an account exists for the recipient with the payment provider. If not, the payment provider may contact the recipient informing them of a pending payment, with a request to create an account to retrieve the payment. Contact may be through email or phone, such as a text message.

After processing, a notification is sent at step 118. The notification may be a denial or approval of the payment request. If the request cannot be processed, the notification may ask the payer to re-enter or enter additional information. The notification may be sent to the payer, the payee, or both. If the payment is approved, the payment is debited from the payer's account and credited to payee's account. As a result, a payment can be processed and made even when the payer is offline.

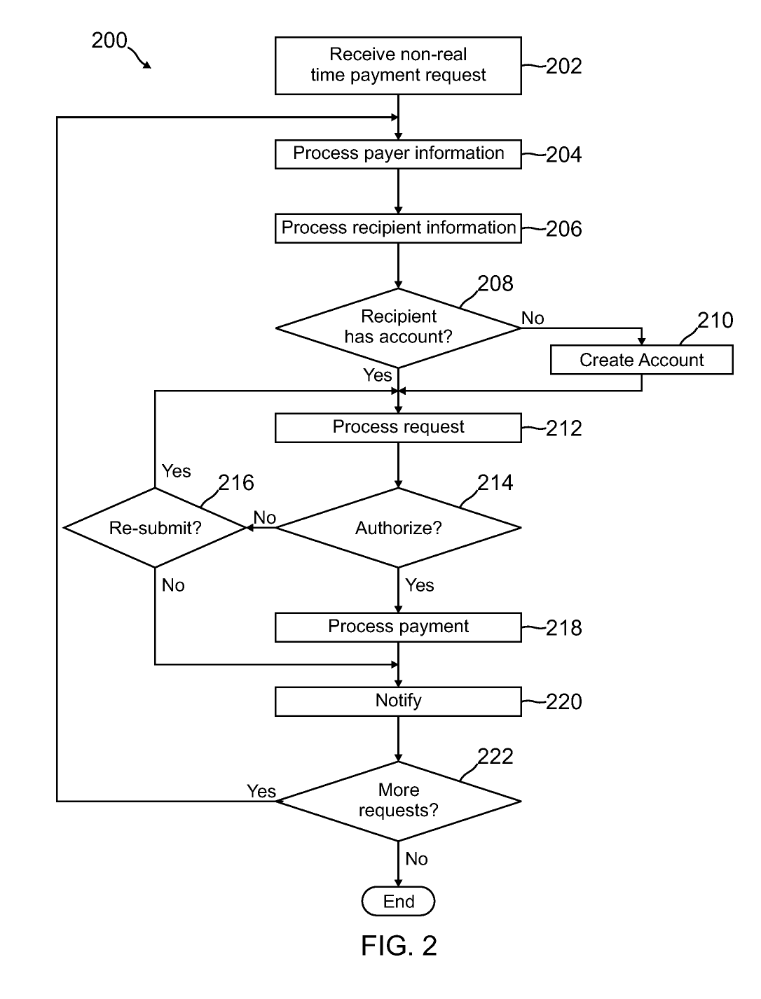

FIG. 2 is a flowchart 200 showing a process for a payment provider in handling an offline payment submission according to one embodiment. At step 202, the payment provider receives a non-real time payment request. The request may be sent from a user device, such as a phone or PC. The key here is that the request is “non-real time.” The request may have been entered while the payment provider was not accessible, such as from a lack of a communication means or problems on the payment provider side. Thus, the payment provider receives the request at some time after the user has entered the payment request and after communication is established or re-established with the payment provider. The request is not received as soon as the user enters and submits the information, as is conventionally done.

After receiving the non-real time payment request, the payment provider processes information, at step 204, about the payer or user that submitted the request. For example, the request may include the user's log in information, such as user name and password. Payer information may also be included in the transmission, such as a phone number, device ID, IP address, and/or cookies. If the user has an account with the payment provider, the payment provider may locate and access the account. If the user does not have an account, the payment provider may either ask the user to create an account or use another funding source of the user, such as a third party bank account or credit card.

The payment also processes recipient or payee information, at step 206. This can be done at the same time as payer information processing or before. The recipient information may be contained in the payment request sent by the payer. For example, the payer may have entered the recipient's email address, phone number, name, business name, web site address, or other identifier. Using the identifier, the payment provider may determine, at step 208, whether the recipient has an account with the payment provider. If so, the recipient account is accessed. If a recipient account cannot be located, the payment provider may ask the recipient to create an account at step 210.

Step 210 may involve notifying the recipient, through email, text, call, or other means, that a payment has arrived. The recipient may also be notified that to retrieve the payment, an account must be created with the payment provider. The recipient can then access the payment provider site, such as through a link or URL address, and enter the requested information for account creation. In other embodiments, the recipient may be asked to provide an account number to deposit the funds, without having to create an account.

Next, at step 212, the payment provider processes the payment request to determine whether the payment can be approved or authorized. This may involve risk analysis, whether the payer has sufficient funds, whether the payment is within limits set for the account, etc. If the payment request cannot be authorized, as determined at step 214, the payment provider may make a determination, at step 216, whether the payer can re-submit the request.

If the request was declined because of a possible submission error, the payment provider can ask the payer to re-submit the request instead of simply declining. In that case, the user can correct or add any additional information, re-submit the payment request, and have the payment provider process the re-submission.

If the request was declined because of a fraudulent request or other reason, the payment provider may not allow the user to re-submit the request, as determined at step 216. In that case, the payment provider sends a notification, at step 220, that the payment request was denied. The notification may be sent to the intended payer and/or the intended recipient.

If the payment request is approved, as determined at step 214, the payment provider processes the payment at step 218. Processing may include debiting the payer's account and crediting the recipient's account with the appropriate amounts.

After processing, the payment provider may notify, at step 220, the payer and/or the recipient of a successful payment. Notification may be through text, email, voice message, or any other suitable means.

Next, the payment provider determines, at step 222, whether there are additional payment requests. This may be the situation where the payer has submitted multiple payment requests while offline. The payment provider then processes any additional payment requests, starting at step 202, 204, or 206. If the payer has specified an order of processing, the payment provider may process the payment requests in the order specified by the payer. The processing continues until all payment requests have been processed.

Consequently, the payment provider may continually process payment requests, even though the requests may have been submitted far apart or in different order. For example, a payer may have submitted two payment requests 48 hours ago and three payment requests 5 hours ago. All five requests may then be processed in succession, either sequentially or in a designed order.

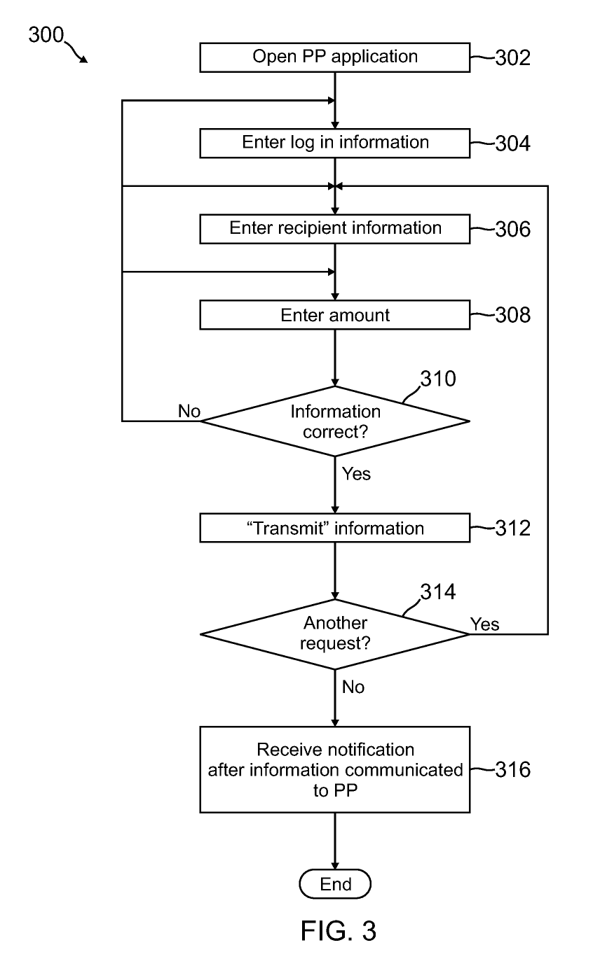

FIG. 3 is a flowchart 300 showing a process for a user or payer in submitting a payment request offline according to another embodiment. At step 302, the user opens an app or other program from the user's device. This can be done by selecting an app on a mobile device, which may have been provided by the payment provider and downloaded onto the user's mobile device.

The user then enters in log in information at step 304 if requested. This may include a user name, email address, password, PIN, phone number, and/or any other identifier. The user may then “enter” the information to get to the next page or screen. At step 306, the user enters recipient information, such as an email address, a phone number for the recipient's mobile device, business name, web site address, other identifier. Again, the user can “enter” this information when completed to get to the next page or screen. At step 308, the user enters the amount of payment. This may be simply entering the amount, but may also include selecting currency. Steps 304, 306, and 308 may be performed sequentially on different pages or screens, all together in one screen, and in any order. The user may also add comments or notes for the payment, such as “for the $10 I owe you,” “for Reference number xxx-xxxx,” “Thanks for lunch,” etc.

After entering desired information, the user determines whether the information is correct at step 310. If any of the entered information is incorrect or should be changed, the user can make the changes in the appropriate fields. Once the user is satisfied with the entered information, the user “transmits” the information at step 312. Because the user (or the user device more specifically) cannot connect to the payment provider, no information is actually transmitted to the payment provider. Instead, the user may select a “submit” or other similar button or link to place the information in a queue ready for transmission when a communication channel is available. Thus, the payment request information is stored on the user's device and ready to transmit when possible.

Step 312 may also include “transmitting” an indication of the payment request to the recipient or payee. The transmitting may be by another form of available communication between devices, such as NFC, Bluetooth, or the like. Thus, even though an Internet or phone connection maybe unavailable, information may still be conveyed between parties. This may be advantageous so that the recipient knows of a pending payment request from the payer, such that the recipient can hold the items/service purchased, and otherwise have a record of an intent to pay from the payer. The information transmitted may be a copy of the payment request, but without any payer confidential information such as log in credentials. If the connection to the payment provider cannot be established because of an isolated problem with the payment provider, the payer may transmit the intent to pay to the payee through any suitable means, including Internet and phone (e.g., WiFi or cellular networks).

If the user wishes to submit another payment request, as determined at step 314, the user can simply enter the recipient and payment information, such as starting at step 306 or 306. There is no need for the user to enter log in information again. The user can thus submit successive multiple payment requests while offline, with each payment request stored and queued for transmission when a connection with the payment provider is established. The user may designated which payment requests to send first; otherwise, priority may default to the first payment request being sent forth, followed by the next, sequentially.

Once the user is finished submitting payment requests, the user may simply waits to receive a notification from the payment provider after communication is established with the payment provider. In this case, the user device attempts to transmit the payment request(s) without the need for the user to do anything. In another embodiment, pending payment request(s) are not transmitted until the user establishes a connection with the payment provider, such as the user trying to access the payment provider site through the user's device.

Regardless of how the payment request(s) are transmitted, once received and processed, the user receives a notification from the payment provider. The notification may be an email, text, or voice message to the user's device, such as a confirmation of the payment, a decline (with or without reason), or a request to correct or resubmit a payment requeset.

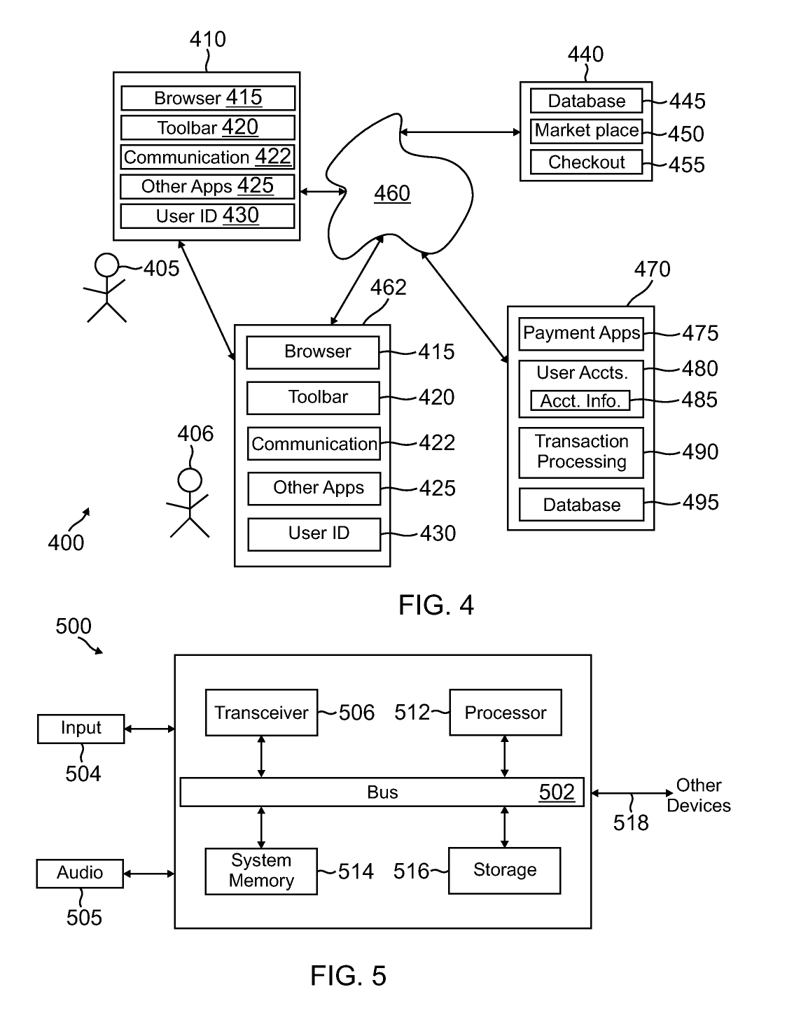

FIG. 4 is a block diagram of a networked system 400 configured to handle a financial transaction between a payer (user) and a payee (recipient), such as described above, in accordance with an embodiment of the invention. System 400 includes a first user device 410, a second user device 462, a merchant server 440, and a payment service provider server 470 in communication over a network 460. Payment service provider server 470 may be maintained by a payment provider, such as PayPal, Inc. of San Jose, Calif. A first user 405, such as a sender person or merchant, utilizes first user device 410, and a second user 406, such as a recipient person or merchant, utilizes and second user device 462 for performing a transaction with a payment provider.

First user device 410, second user device 462, merchant server 440, and payment service provider server 470 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 400, and/or accessible over network 460.

Network 460 may be implemented as a single network or a combination of multiple networks. For example, in various embodiments, network 460 may include the Internet or one or more intranets, landline networks, wireless networks, and/or other appropriate types of networks.

First user device 410 and second user device 462 may be implemented using any appropriate hardware and software configured for wired and/or wireless communication over network 460. For example, in one embodiment, the two user devices may be implemented as a personal computer (PC), a smart phone, personal digital assistant (PDA), laptop computer, and/or other types of computing devices capable of transmitting and/or receiving data, such as an iPad™ from Apple™.

First user device 410 may include one or more browser applications 415 which may be used, for example, to provide a convenient interface to permit first user 405 to browse information available over network 460. For example, in one embodiment, browser application 415 may be implemented as a web browser configured to view information available over the Internet. First user device 410 may also include one or more toolbar applications 420 which may be used, for example, to provide client-side processing for performing desired tasks in response to operations selected by first user 405. In one embodiment, toolbar application 420 may display a user interface in connection with browser application 415 as further described herein.

First user device 410 may further include other applications 425 as may be desired in particular embodiments to provide desired features to first user device 410. For example, other applications 425 may include security applications for implementing client-side security features, programmatic client applications for interfacing with appropriate application programming interfaces (APIs) over network 460, or other types of applications. Applications 425 may also include email, texting, voice and IM applications that allow first user 405 to send and receive emails, calls, and texts through network 460, as well as from a payment provider to process and store payment requests as discussed above. First user device 410 includes one or more user identifiers 430 which may be implemented, for example, as operating system registry entries, cookies associated with browser application 415, identifiers associated with hardware of first user device 410, or other appropriate identifiers, such as used for payment/user/device authentication. In one embodiment, user identifier 430 may be used by a payment provider to associate first user 405 with a particular account maintained by the payment provider as further described herein. A communications application 422, with associated interfaces, enables first user device 410 to communicate within system 400.

Second user device 462 may have similar applications and modules as first user device 410, but is used, in this example, for receiving payment or money from first user 405. Second user device 462 may also include one or more browser applications 415 and one or more toolbar applications 420 which may be used, for example, to provide a convenient interface to permit second user 406 to browse information and perform tasks over network 460. For example, in one embodiment, browser application 415 may be implemented as a web browser configured to view information available over the Internet and communicate with merchant server 440 to receive and send information about purchases made through merchant server 440.

Second user device 462 may further include other applications 425 such as security applications for implementing client-side security features, programmatic client applications for interfacing with appropriate application programming interfaces (APIs) over network 460, or other types of applications. Applications 425 may also include email, text, IM, and voice applications that allow second user 406 to communicate through network 460 and receive funds through network 460. Second user device 462 includes one or more user identifiers 430 which may be implemented, for example, as operating system registry entries, cookies associated with browser application 415, identifiers associated with hardware of second user device 462, or other appropriate identifiers, such as used for payment/user/device authentication, e.g., the phone number associated with second user device 462. Identifiers may be used by a payment service provider to associate second user 406 with a particular account maintained by the payment service provider.

Merchant server 440 may be maintained, for example, by an on-line merchant offering various products and/or services in exchange for payment to be received over network 460. Merchant server 440 includes a database 445 identifying available products and/or services (e.g., collectively referred to as items) which may be made available for viewing and purchase by first user 405. Accordingly, merchant server 440 also includes a marketplace application 450 which may be configured to serve information over network 460 to browser 415 of first user device 410 and second user device 462. In one embodiment, first user 405 may interact with marketplace application 450 through browser applications over network 460 in order to view various products or services identified in database 445.

Merchant server 440 also includes a checkout application 455 which may be configured to facilitate the purchase by first user 405 of goods or services identified by marketplace application 450. Checkout application 455 may be configured to accept payment information from first user 405 through payment service provider server 470 over network 460. For example, checkout application 455 may receive and process a payment confirmation from payment service provider server 470, as well as transmit transaction information to the payment provider and receive information from the payment provider (e.g., a transaction ID). Checkout application 455 may also enable payment through second user device 462 in communication with the payment provider by using a payment link as described herein.

Payment service provider server 470 may be maintained, for example, by an online payment service provider which may provide payment between first user 405, second user 406, and the operator of merchant server 440. In this regard, payment service provider server 470 includes one or more payment applications 475 which may be configured to interact with first user device 410, second user device 462, and/or merchant server 440 over network 460 to facilitate the purchase of goods or services by first user 405 of first user device 410 or payment between first user device 410 and second user device 462.

Payment service provider server 470 also maintains a plurality of user accounts 480, each of which may include account information 485 associated with individual users. For example, account information 485 may include private financial information of users of devices such as account numbers, passwords, device identifiers, user names, phone numbers, credit card information, bank information, or other financial information which may be used to facilitate online transactions by first user 405. Advantageously, payment application 475 may be configured to interact with merchant server 440 on behalf of first user 405 during a transaction with checkout application 455 to track and manage purchases made by users.

A transaction processing application 490, which may be part of payment application 475 or separate, may be configured to receive information from a user device and/or merchant server 440 for processing and storage in a payment database 495. Transaction processing application 490 may include one or more applications to process information from a payment request from first user 405 to either second user 406 or a merchant associated with merchant server 440. Other funding sources may also be processed through this application. Payment application 475 may be further configured to determine the existence of accounts for first user 405 and/or second user 406, as well as create new accounts if necessary.

Note that in different embodiments, system 400, merchant server 440 or second user device 462 is not needed if the payment request from first user 405 is directly to only one of the entities.

FIG. 5 is a block diagram of a computer system 500 suitable for implementing one or more embodiments of the present disclosure. In various implementations, the user device may comprise a personal computing device (e.g., a personal computer, laptop, smart phone, PDA, Bluetooth device, key FOB, badge, etc.) capable of communicating with the network. The merchant and/or payment provider may utilize a network computing device (e.g., a network server) capable of communicating with the network. It should be appreciated that each of the devices utilized by users, merchants, and payment providers may be implemented as computer system 500 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard (creating the payment link), selecting one or more buttons or links (accessing the payment link), etc., and sends a corresponding signal to bus 502. I/O component 504 may also include an output component, such as a display. An optional audio input/output component 505 may also be included to allow a user to use voice for inputting information by converting audio signals. Audio I/O component 505 may allow the user to hear audio. A transceiver 506 transmits and receives signals between computer system 500 and other devices, such as another user device, a merchant server, or a payment provider server. In one embodiment, the transmission is wireless, although other transmission mediums and methods may also be suitable. A processor 512, which can be a micro-controller, digital signal processor (DSP), or other processing component, processes these various signals, such as for display on computer system 500 or transmission to other devices via a communication link 518. Processor 512 may also control transmission of information, such as cookies or IP addresses, to other devices.

Components of computer system 500 also include a system memory component 514 (e.g., RAM) and a static storage component 516 (e.g., ROM). Memory may be used to store pending or queued payment requests submitted while the device was “offline.” Computer system 500 performs specific operations by processor 512 and other components by executing one or more sequences of instructions contained in system memory component 514. Logic may be encoded in a computer readable medium, which may refer to any medium that participates in providing instructions to processor 512 for execution. Such a medium may take many forms, including but not limited to, non-volatile media, volatile media, and transmission media. In various implementations, non-volatile media includes optical or magnetic disks, volatile media includes dynamic memory, such as system memory component 514, and transmission media includes coaxial cables, copper wire, and fiber optics, including wires that comprise bus 502. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A method of performing financial transactions, comprising:
receiving, by a processor of a payment provider, a non-real time electronic payment request from a first user to a second user, wherein the payment request was submitted by the first user when a connection to the payment provider was not available;
processing, by the processor, information from the payment request; and
transferring an amount of the funds to an account of the second user if the payment request is approved.

2. The method of claim 1, wherein the payment request was submitted by the first user when no communication with the payment provider was established.

3. The method of claim 1, further comprising determining, by the processor, whether the first user has an account with the payment provider.

4. The method of claim 3, wherein the determining comprises processing a device identifier from the first user used in transmitting the payment request to the payment provider.

5. The method of claim 1, wherein the receiving is immediately after a connection is established between a device of the first user and the payment provider.

6. The method of claim 1, further comprising receiving additional non-real time payment requests from the first user, wherein the additional non-real time payment requests were submitted by the first user when no communication with the payment provider was established.

7. The method of claim 1, wherein the payment request comprises information about the second user and an amount.

8. The method of claim 1, wherein the non-real time payment request is received from a mobile device of the first user.

9. The method of claim 6, wherein the non-real time payment requests are processed in the order submitted by the first user.

10. The method of claim 6, wherein the non-real time payment requests are processed in an order designated by the first user.

11. A machine-readable medium comprising a plurality of machine-readable instructions which when executed by one or more processors of a server are adapted to cause the server to perform a method comprising:
receiving, by a payment provider, a non-real time electronic payment request from a first user to a second user, wherein the payment request was submitted by the first user when a connection to the payment provider was not available;
processing information from the payment request; and
transferring an amount of the funds to an account of the second user if the payment request is approved.

12. The machine-readable medium of claim 11, wherein the payment request was submitted by the first user when no communication with the payment provider was established.

13. The machine-readable medium of claim 11, wherein the method further comprises determining whether the first user has an account with the payment provider.

14. machine-readable medium of claim 13, wherein the determining comprises processing a device identifier from the first user used in transmitting the payment request to the payment provider.

15. The machine-readable medium of claim 11, wherein the receiving is immediately after a connection is established between a device of the first user and the payment provider.

16. The machine-readable medium of claim 11, wherein the method further comprises receiving additional non-real time payment requests from the first user, wherein the additional non-real time payment requests were submitted by the first user when no communication with the payment provider was established.

17. The machine-readable medium of claim 16, wherein the non-real time payment requests are processed in the order submitted by the first user.

18. The machine-readable medium of claim 16, wherein the non-real time payment requests are processed in an order designated by the first user.

19. An electronic payment processing system comprising:
means for receiving, by a payment provider, a non-real time electronic payment request from a first user to a second user, wherein the payment request was submitted by the first user when a connection to the payment provider was not available;
means for processing information from the payment request; and
means for transferring an amount of the funds to an account of the second user if the payment request is approved.

20. The system of claim 19, wherein the payment request was submitted by the first user when no communication with the payment provider was established
